(19) United States
(12) Patent Application Publication
(10) Pub. No.: US 2014/0116957 A1
(43) Pub. Date: May 1, 2014

(54) FLOATING FILTER MODULE AND WATER TREATMENT APPARATUS AND METHOD USING THE SAME

(71) Applicants: Kwang Jae Woo, Daejeon (KR); Yeon Gil Kim, Daejeon (KR); Wan Jung Kim, Daejeon (KR)

(72) Inventors: Kwang Jae Woo, Daejeon (KR); Yeon Gil Kim, Daejeon (KR); Wan Jung Kim, Daejeon (KR)

(73) Assignee: DAEWOONG ECOSYSTEMS AND SOLUTION, Chungcheongnam-do (KR)

(21) Appl. No.: 14/119,443

(22) PCT Filed: Apr. 17, 2012
(86) PCT No.: PCT/KR2012/002912

§ 371 Date: Nov. 21, 2013

(30) Foreign Application Priority Data
Jun. 23, 2011 (KR) 10-2011-0061070
Jun. 23, 2011 (KR) 10-2011-0061077

(51) Int. Cl. C02F 1/00; C02F 3/30; C02F 3/12; B01D 35/05; B01D 35/16

(52) U.S. Cl. CPC C02F 1/001; B01D 35/05; B01D 35/16; C02F 3/1263; C02F 3/30
USPC 210/744; 210/242.1; 210/242.2; 210/97; 210/85; 210/151; 210/798

(57) ABSTRACT

The present invention relates to a floating filter module installed in a water treatment apparatus, such as in a public water treatment plant, a village water supply facility, a public sewage treatment plant, a wastewater treatment plant, or a village sewage treatment plant, in order to remove contamination particles. The floating filter module according to the present invention comprises: a hollow-type sintered filter having a plurality of fine pores which is arranged in wastewater within a water treatment tank in order to separate and filter the contamination particles from the wastewater introduced into the water treatment tank; a floating body connected to the sintered filter, and which floats to the surface of the wastewater within the water treatment tank so as to position the sintered filter at the upper portion of the wastewater in the water treatment tank; a main pipe communicating with an inner space of the sintered filter; a suction device coupled to the main pipe in order to provide a suction force to the sintered filter through the main pipe, thereby suctioning the wastewater in the water treatment tank through the plurality of fine pores and into the sintered filter; and a compressed-air supply apparatus having a compressed-air supply tube communicating with the inner space of the sintered filter through the main tube and an air compressor coupled to the compressed-air supply tube in order to supply compressed air into the inner space of the sintered filter, thereby releasing from the sintered filter the contamination particles that clog the fine pores of the sintered filter.

### BACKGROUND OF THE INVENTION

1. Field of the Invention

The present invention relates to a floating filter module to remove micro-pollution particles, which is installed in a water treatment apparatus, such as in a public water treatment plant, a village water supply facility, a public sewage treatment plant, a wastewater treatment plant, or a village sewage treatment plant. More particularly, the present invention relates to a floating filter module for separating and filtering the upper water which is placed in the upper side of a wastewater tank and have relatively low concentration of suspension solids, and a water treatment apparatus and a method using the floating filter module.

2. Description of the Related Art

Environmental pollution like soil and air contaminations and global warming is becoming increasingly serious, and the amount of sewage, wastewater or dirty water (hereinafter referred to as the “wastewater”) has been greatly increased. As a result, treatment facilities have been developed highly and the cost for processing wastewater is on the increase. Moreover, various water pollutants are not processed perfectly and can be introduced into rivers or rakes which may be used as source water. Therefore, it is difficult to manage the quality of water effectively.

The water treatment techniques for treating and purifying wastewater are divided into physicochemical treatment and biological treatment. Examples of physicochemical treatment are such methods as filtering, chemical coagulation, precipitation and oxidation treatment. In the biological treatment, various pollutants are removed by maximizing metabolic process of microorganism in bioreactor retaining activated sludge. Biological treatment is mostly used for wastewater treatment.

In physicochemical water treatment, the method for separating and filtering micro-pollution particles is added in the existing treatment facility without big change, and is effective for removing total phosphorus (T-P) as well as micro-pollution particles. Examples of the method and apparatus for separating and filtering micro-pollution particles are as follows.

Registered Korean Patent No. 0558510, there is disclosed a high class wastewater treatment apparatus using an immersion type membrane separator. The patent discloses that, in the wastewater treatment apparatus using microbial response, suspended solids (SS) and colon bacillus of wastewater are removed by using a membrane bio-reactor (MBR) instead of a precipitation tank.

Registered Korean Patent No. 0843656, there is disclosed a water treatment apparatus in which an immersion type membrane bio-reactor is installed in two stages. The patent discloses a first membrane filtration tank which includes an immersion type membrane separator; a suction pump by which the membrane separator communicates with a storage tank and the source water of the membrane filtration tank is forcibly sucked to transfer to the storage tank; and an aeration tube for removing adhesion floating matters from the membrane separator by supplying air, and a second membrane filtration tank which includes an immersion type membrane separator; a suction pump by which the membrane separator communicates with a storage tank and the source water of the membrane filter tank is forcibly sucked to transfer to the storage tank; and an aeration tube for removing adhesion floating matters from the membrane separator.

Registered Korean Patent No. 0875733, there is disclosed a technique using an immersion type membrane separator. According to the above technique, return sludge is supplied to the a reactor in accordance with the load change of the inflowing water to remove nutrient salts such as nitrogen and phosphorus included in the inflowing water, and the quantity of sludge is controlled in accordance with phosphorus concentration to improve the quality of treatment water.

Registered Korean Patent No. 0718791, there is disclosed an immersion type filtering apparatus for processing water. According to the above apparatus, when plenty of foreign materials are deposited on the surface of a immersion type filter for filtering foreign materials included in water, strong compressed air is injected momentarily into the filter to remove the foreign materials deposited on the surface of the filter.

Registered Korean Patent No. 1000742, there is disclosed a water treatment method for effectively removing phosphorus content that is a main cause substance of eutrophication. The patent discloses a micro-particles separating means which separates easily micro-pollution particles from wastewater.

Registered Korean Patent No. 0489328, there is disclosed a high class treatment apparatus for processing organic material, nitrogen and phosphorus included in wastewater. The patent discloses an immersion type membrane bio-reactor which decomposes organic material by using aerobic microbes, accumulates phosphorus, oxidizes ammoniacal nitrogen and separates sludge and wastewater through a membrane separating module.

According to these conventional techniques, however, an immersion type membrane separator is placed in the middle or lower portion of a treatment tank in which the concentration of suspended solids or mixed liquor suspended solids (SS or MLSS) is relatively high. Thus, there is a problem that the micro pores of the immersion type membrane separator are clogged for a short time, thereby drastically decreasing the separating and filtering efficiency of micro-pollution particles.

In addition, with the conventional techniques, the immersion type membrane separator having the clogged micro pores cannot be cleaned efficiently. For example, according to registered Korean Patent No. 0718791, there is disclosed that the immersion type membrane separator is cleaned by using compressed air. However, there is a problem that, after cleaning, the inside of the immersion type membrane separator is filled with air so that a suction pump become hollow in re-suction process of the immersion type membrane separator. In addition, according to the registered Korean Patent No. 1000742 or 0489328, there is disclosed that the immersion type membrane separator having the clogged micro pores is cleaned by returning wastewater. However, this method has a problem that the cleaning time is increased.

### SUMMARY OF THE INVENTION

The present invention has been proposed to solve the problem aforementioned, and it is an object of the present invention to provide a floating filter module and a water treatment apparatus and method using it, which are capable of improving filtration rate and filtration duration time by separating and filtering only upper water having relatively low concentration of suspended solids in a wastewater tank.

It is also another object of the present invention to provide a floating filter module and a water treatment apparatus and method using it, which are capable of reducing of the adhesion amount of micro-pollution particles in a separating and filtering process and removing the adhered micro-pollution particles effectively and quickly when filtration rate is decreased due to adhering of micro-pollution particles.

In order to accomplish the objects, a floating filter module according to the present invention comprises a hollow-type sintered filter arranged in wastewater of the water treatment tank and having a plurality of micro-pores, for separating and filtering the micro-pollution particles from the wastewater introduced into the water treatment tank; a floating body coupled with the sintered filter and floated to the surface of the wastewater in the water treatment tank, for placing the sintered filter at the upper side of the wastewater in the water treatment tank; a main pipe for connecting to an inside space of the sintered filter; a suction device coupled to the main pipe and providing suction force to the sintered filter through the main pipe, for sucking the wastewater of the water treatment tank into the inside space of the sintered filter through the plurality of micro-pores; and a compressed-air supply device having a compressed-air supply pipe connecting with the inside space of the sintered filter through the main pipe and an air compressor coupled with the compressed-air supply pipe, for supplying compressed air into the inside space of the sintered filter to remove the micro-pollution particles that clog the micro-pores of the sintered filter.

The floating filter module according to the present invention may further comprise a vibration generating device for vibrating the sintered filter to remove the micro-pollution particles that clogs the micro-pores of the sintered filter.

The floating filter module according to the present invention may further comprise a makeup water supply device for supplying makeup water in the inside space of the sintered filter filled with air by the compressed-air supply device. The makeup water supply device is connected to the main pipe.

It is desirable that the sintered filter is made of stainless metal or synthetic resin.

The suction device may comprise a suction pump and a differential pressure detector. The suction pump is connected with the main pump to generate suction force, and the differential pressure detector detects the difference between the forward and backward pressures of the suction pump to detect the blockage degree of the sintered filter.

The compressed-air supply device may further comprise an actuator arranged between the sintered filter and the air compressor, for converting the compressed air to pulse form, the compressed air being continuously supplied from the air compressor to the sintered filter.

In order to accomplish the objects, a water treatment apparatus according to the present invention comprises a water treatment tank into which wastewater is introduced; a floating filter module arranged in the water treatment tank, for separating and filtering the micro-pollution particles from the wastewater introduced into the water treatment tank; a control device for controlling operations of the floating filter module. The floating filter module comprises a hollow-type sintered filter arranged in the wastewater of the water treatment tank and having a plurality of micro-pores; a floating body coupled with the sintered filter and floated to the surface of the wastewater in the water treatment tank, for placing the sintered filter at the upper position of the wastewater in the water treatment tank; a main pipe for connecting with an inside space of the sintered filter; a suction device coupled to the main pipe and providing suction force to the sintered filter through the main pipe, for sucking the wastewater of the water treatment tank into the inside space of the sintered filter through the plurality of micro-pores; and a compressed-air supply device having a compressed-air supply pipe connecting with the inside space of the sintered filter through the main pipe and an air compressor coupled with the compressed-air supply pipe, the compressed-air supply device supplying compressed air into the inside space of the sintered filter to remove the micro-pollution particles that clog the micro-pores of the sintered filter.

In order to accomplish the objects, the water treatment method according to the present invention comprises the steps of: (a) arranging a hollow-type sintered filter having a plurality of micro-pores in the upper side of wastewater in the water treatment tank, by using of a floating body capable of floating on the surface of water; (b) separating and filtering the micro-pollution particles from the wastewater, by providing suction force for the sintered filter and by sucking the wastewater of the water treatment tank into the inside space of the sintered filter through the plurality of micro-pores; (c) detecting the blockage degree of the sintered filter; (d) cleaning the sintered filter with returning of filtration water and spraying of compressed air to the inside space of the sintered filter, by stopping a suction device for providing the sintered filter with suction force and by supplying compressed air into the inside space of the sintered filter for a period of time, when the blockage degree of the sintered filter reaches a preset value, and (e) stopping a compressed air supply device for supplying compressed air to the sintered filter and restarting the suction device, after the cleaning of the sintered filter.

The floating filter module according to the present invention uses a semi-permanent sintered filter in which micro pores are hardly deformed. This reduces the risk of damage and increase lifespan.

In addition, the floating filter module according to the present invention is a moveable floating type and placed in the upper side of the water treatment tank, and separates and filters the upper water having relatively low concentration of suspended solids. Therefore, filtration rate and filtration duration time is excellent compared with the conventional apparatus.

In addition, the floating filter module according to the present invention, when the clogging of the sintered filter is occurred, can remove micro-pollution particles adhered to the sintered filter quickly and efficiently, with returning filtration water and spraying the compressed air.

In addition, the floating filter module according to the present invention, when the clogging of the sintered filter is occurred, can clean the sintered filter efficiently without using chemicals as before. Therefore, the activity degradation of microorganism due to chemicals is not occurred.

In addition, the floating filter module according to the present invention vibrates the sintered filter by using a vibration generating device so that micro-pollution particles are hardly adhered to the sintered filter. Therefore, it is possible to reduce the frequency of the cleaning process, and operate efficiently.

### BRIEF DESCRIPTION OF THE DRAWINGS

FIG. 1 is a flowsheet showing the wastewater treatment processes of a water treatment apparatus according to a first embodiment of the present invention.

FIG. 2 is a block diagram showing some configuration of a water treatment apparatus according to a first embodiment of the present invention.

FIG. 3 is a side view schematically showing a filtration tank of a water treatment apparatus according to a first embodiment of the present invention.

FIG. 4 is a side view showing a floating filter module according to an embodiment of the present invention.

FIG. 5 is a top view taken along the line I-I of FIG. 4.

FIG. 6 is a side cross sectional view showing a sintered filter of a floating filter module according to an embodiment of the present invention.

FIG. 7 is a view showing a manufacturing process of a sintered filter provided in a floating filter module according to an embodiment of the present invention.

FIG. 8 is a flowsheet showing the wastewater treatment processes of a water treatment apparatus according to a second embodiment of the present invention.

FIG. 9 is a top view schematically showing a water treatment apparatus according to a second embodiment of the present invention.

FIG. 10 is a side view schematically showing an aeration tank of a water treatment apparatus according to a second embodiment of the present invention.

FIG. 11 is a flowsheet showing the wastewater treatment processes of a water treatment apparatus according to a third embodiment of the present invention.

FIG. 12 is a top view schematically showing a water treatment apparatus according to a third embodiment of the present invention.

FIG. 13 is a side view schematically showing a sequencing batch reactor of a water treatment apparatus according to a third embodiment of the present invention.

FIG. 14 is a flowsheet showing the wastewater treatment processes of a water treatment apparatus according to a forth embodiment of the present invention.

FIG. 15 is a top view schematically showing a water treatment apparatus according to a forth embodiment of the present invention.

FIG. 16 is a view respectively showing (a) an installation initial state, (b) a state after sucking and filtering and (c) a state after cleaning with compressed air, of a sintered filter installed in a sequencing batch reactor.

FIG. 17 is a graph showing filtering characteristics according to the operation of a floating filter module installed in a sequencing batch reactor.

### DETAILED DESCRIPTION OF THE INVENTION

Hereinafter, the present invention will be described by way of examples illustrating best mode embodiments. Examples described below are only for illustrative purposes. Therefore, the scope of the present invention is limited only by the scope of the claims, but not to the examples.

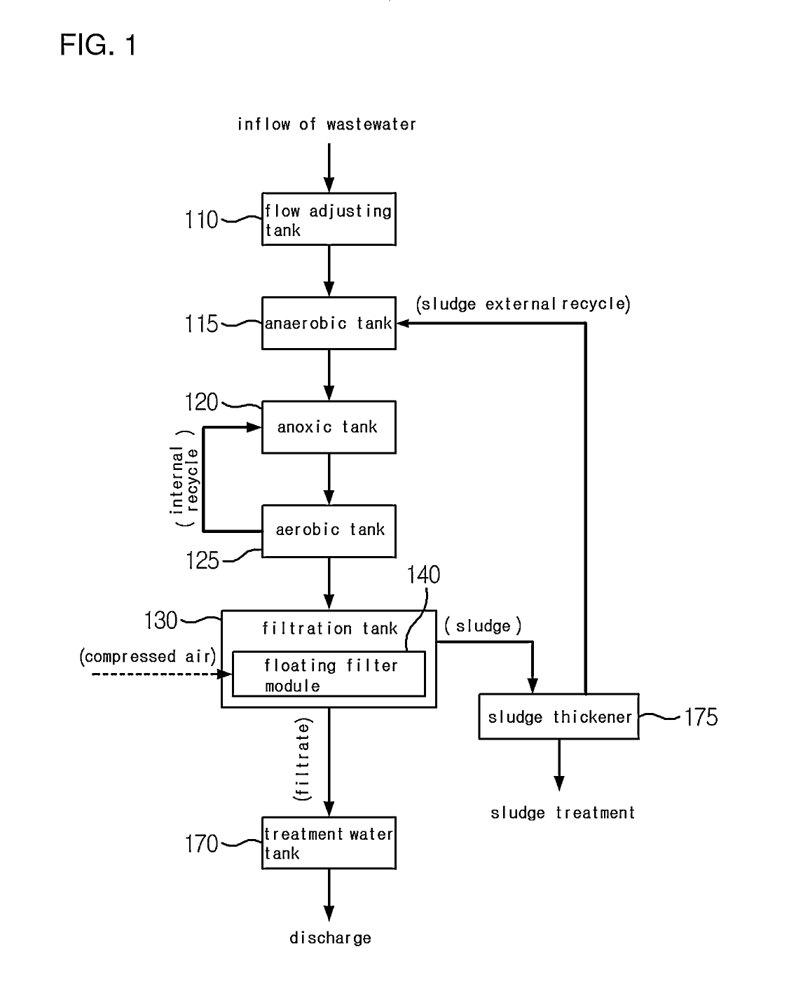

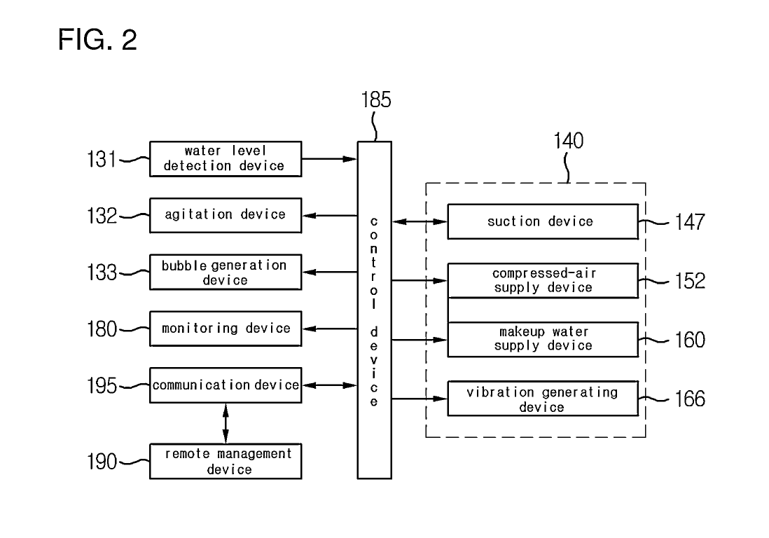

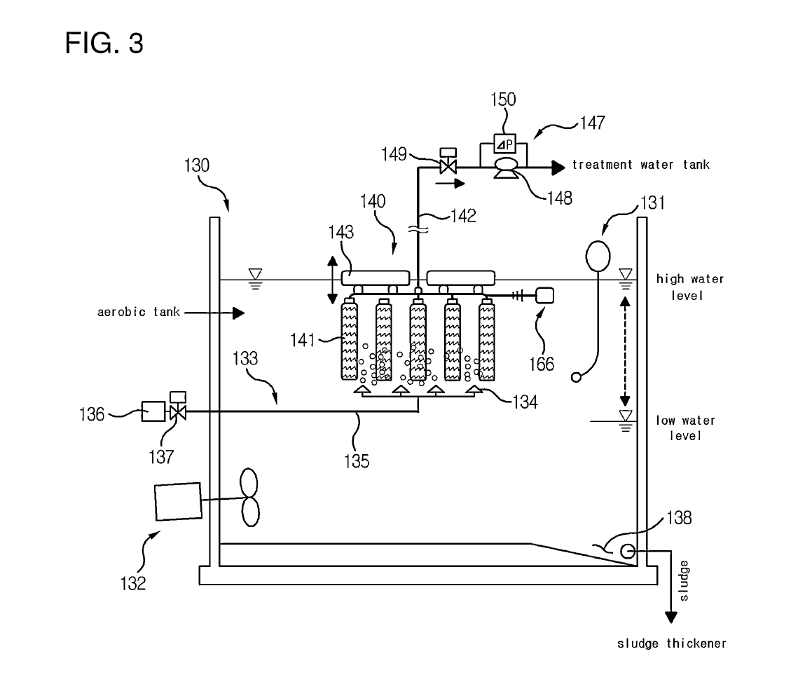

FIG. 1 is a flowsheet showing the wastewater treatment processes of a water treatment apparatus according to a first embodiment of the present invention, FIG. 2 is a block diagram showing some configuration of a water treatment apparatus according to a first embodiment of the present invention, and FIG. 3 is a side view schematically showing a filtration tank of the water treatment apparatus shown FIG. 3.

As shown in FIGS. 1 to 3, a first embodiment of the present invention is an A₂/O (Anaerobic/Anoxic/Oxic) type of water treatment apparatus which includes three stages of bio-reactors comprising anaerobic tank 115, anoxic tank 120 and aerobic tank 125, and a plurality of treatment tanks arranged in the upper and downstream of the bio-reactors. Additional treatment tanks except for the three stages of bio-reactors are a flow rate control tank 110 arranged in the upper stream of the anaerobic tank 115, a filtration tank 130 arranged in the lower stream of the anoxic tank 120, a processing water tank 170 and a sludge thickener 175. A floating filter module 140 for separating and filtering wastewater is arranged in the filtration tank 130.

In addition, the water treatment apparatus according to the first embodiment of the present invention further includes a water level detection device 131 for detecting the water level of the filtration tank 130, a agitation device 132 for agitating the wastewater of the filtration tank 130, a bubble generating device 133 for supplying bubbles to the floating filter module 140, a monitoring device 180 for providing the water treatment processing state for a user, a control device 185 for controlling various devices, a remote management device 190 for providing a manager with information about the water treatment processing state and allowing the manager to control remotely the water treatment processes, and a communication device 195 for communication between the control device 185 and the remote management device 190.

A bubble generating device 133 includes a plurality of aeration tubes 134 arranged in the lower position of the floating filter module 140, an air supply device 136 for introducing air into the aeration tubes 134 through an air supply tube 135, and an air control valve 137, arranged in the air supply tube 135, for opening and closing air path in the air supply tube 135. The air supply device 136 and the air control valve 137 are controlled by the control device 185. The bubble generating device 33 generates bubbles through the plurality of aeration tubes 134 and provides the sintered filter 141 of the floating filter module 140. This removes micro-pollution particles adhered to the sintered filter 141 and prevent micro-pollution particles from being adhered to the sintered filter 141. The plurality of aeration tubes 134 are coupled to the floating filter module 140 through a separate coupling device, thereby not interfering with the floating filter module 140 for elevating according to the water level of wastewater. Thus, the aeration tubes 134 can be elevated with the floating filter module 140 and installed in the bottom of the filtration tank.

The communication device 195 connects the control device 185 with the remote management device 190 so that a manager who is far away checks the progress of the water treatment processes or the state of the water treatment apparatus through the remote management device 190 in real time and controls the water treatment processes remotely.

This A₂/O type of water treatment apparatus is most basic and high class of biological treatment apparatus for effectively removing total nitrogen (T-N) and total phosphorus (T-P) nutrient salts in addition to biochemical oxygen demand (BOD) and suspension floating material in wastewater. An ordinary activated sludge type of conventional biological reactor is comprised of only the activated sludge of aerobic tank so that the wastewater processed in the aerobic tank is precipitated in a precipitation tank and then discharged. This degrades the efficiency of removing nitrogen and phosphorus and causes eutrophication when discharging in the river. However, the A₂/O type of water treatment apparatus, in which bio-reactor comprises an anaerobic tank 115, an anoxic tank 120 and an aerobic tank 125, can solve the conventional problems.

According to the water treatment processes executed by the water treatment apparatus of the first embodiment of the present invention, an anaerobic tank 115 and an anoxic tank 120 are installed in the upper stream of an aerobic tank 125, the wastewater processed in the aerobic tank 125 is returned to the anoxic tank 120 to remove nitrate nitrogen NO₃—N, and a portion of activated sludge precipitated in the filtration tank 130 is returned from the upper stream of the sludge thickener 175 to the anaerobic tank 115. Thus, microbial concentration of all reactors remains constant. Further, by releasing phosphorus in anaerobic state and taking in superfluous phosphorus, the phosphorus is pulled out sludge state and then removed.

The water treatment process of the water treatment apparatus according to the first embodiment of the present invention includes an internal recycle for removing nitrate nitrogen and an external recycle of sludge from the filtration tank for removing phosphorus. With this, phosphorus can be released from anaerobic tank 115 and microorganism can ingest phosphorus superfluously in the aerobic tank 125 so that the total phosphorus content ratio of the activated sludge is increased and the total phosphorus removal ratio of wastewater is increased. Therefore, nitride nitrogen in internal recycle water from the aerobic tank 125 is denitrified in the anoxic tank 120 and reduced to nitrogen gas so that nitrogen is removed from wastewater.

The processing efficiency in the A₂O type of water treatment process is generally known as follows: the removal rate of biological oxygen demand (BOD) is more than 90%, the removal rate of suspended floating matter is more than 90%, the removal rate of total nitrogen is 40˜70%, and the removal rate of total phosphorus is about 60%. Further, the hydraulic retention time (HRT) is 5˜8 hours (the anaerobic tank: 0.5˜1.0 hours, the anoxic tank: 0.5˜1.0 hours, and the aerobic tank: 3.5˜6.0 hours), the solids retention time (SRT) is 4˜27 days, the external rate of the returned activated sludge (RAS) is 25˜50%, and the internal rate of the inlet water quantity (Q) is about 100˜200%.

The water treatment apparatus according to the first embodiment of the present invention has an additional function of separating and filtering micro-pollution particles with using a filtration tank 130 installed a floating filter module 140 so that the treatment efficiency of suspended floating matter is higher than that of conventional A₂/O type of wastewater treatment process. By using a floating filter module 140, a forced pressure type of separating and filtering process is adopted instead of gravitational settling type, thereby being capable of processing the suspended floating matter stably and efficiently.

In case of a water treatment apparatus having a conventional immersion type membrane separator, the immersion type membrane separator is arranged in the lower stream of a bio-reactor and waste water is discharged by using immersion type membrane which is installed in the separator. The conventional immersion type membrane, which is made of 0.01˜1.0 μm grade of a hollow fiber membrane or a plate type membrane, is fixed in the lower part of the membrane separator, thereby being exposed to suspended solids having relatively high concentration. Therefore, their initial filtration efficiency is satisfactory, but as operating time goes by, it causes clogging of micro-pores, that is, blockage of micro-pores due to deposition of micro-pollution particles or microorganism, in a short period of time, thereby decreasing the filtration efficiency sharply.

In case that of the conventional water treatment apparatus, when the clogging of micro-pores is occurred in the immersion type membrane, generally the membrane is cleaned by inputting cleaning chemicals and flowing high pressure treatment water backward, namely back-washing. But this method for cleaning the immersion type membrane has several problems that the activity of microorganism is degraded by inputting chemicals, total filtration throughput is decreased by flowing treatment water backward, and the initial cost, electricity cost and maintenance cost is increased by installing equipment for inputting chemicals and a pump for back-washing.

In addition to the clogging of fine holes, self-defects may occurs in the hollow fiber membrane used in the immersion type membrane of the conventional water treatment apparatus, thereby easily degrading the efficiency of the filtration. Generally, one element of the hollow fiber membrane comprises about 160 strands of hollow filers with 2 mm of external diameter, 0.8 mm of internal diameter, 1.5 m of length and 0.1 μm of pore size. However, in this hollow fiber membrane, the hollow fibers may be easily snapped or destroyed while using it. Thus, it is difficult to keep the treatment efficiency stably. Further, the hollow fiber membrane used in the convention immersion type membrane cannot be cleaned by using compressed air because of the thickness and material of membrane, thereby restricting the cleaning method.

In the present invention, because a floating filter module 140 including a sintered filter 141 is used, the problems of the prior art can be solved. As shown FIGS. 2 to 4, the floating filter module 140 according to an embodiment of the present invention is arranged to float on the upper side of water in the filtration tank 130 so that only upper water, whose suspended solids concentration is relatively low, is separated and filtered. Therefore, in addition to excellent initial filtration efficiency, the floating filter module 140 has a stable efficiency, even though over time. Even if micro-pores are clogged by adhering of micro-pollution particles or microorganism, they are rapidly cleaned by spraying of air and returning of treatment water.

As shown FIGS. 3 to 5, the floating filter module 140 installed in the filtration tank 130 has a plurality of sintered filters 141 immerged within wastewater of the filtration tanks 130, a main pipe 142 connected to the sintered filters 141, a plurality of floating bodies 143 for placing the sintered filters at the upper position in the wastewater by floating to the water surface with buoyancy, a suction device 147 connected to the sintered filters 141, for providing suction force to the sintered filters 141, a compressed-air supply device 152 for providing the compressed-air to the sintered filters 141 so as to remove micro-pollution particles deposited on the sintered filters 141, a makeup water supply device 160 for providing makeup water to the inside space of the sintered filters 141 filled with air after cleaning the sintered filters, a vibration generating device 166 for vibrating the sintered filters 141 so as to remove micro-pollution particles deposited on the sintered filters 141. In the floating filter module 140 of FIG. 3, the compressed-air supply device 152 and the makeup water supply device 160 are omitted for clarity.

In the floating filter module 140 according to the present invention, the sintered filters 141 for separating and filtering are arranged in upper side of wastewater in the filtration tanks 130 by buoyancy of the floating bodies 143, and elevated up and down by changing of water level, thereby separating and filtering only upper water having relatively low concentration of suspension solids. Therefore, the filtration speed, the filtration rate of filtrate flux and filtrate duration time are far superior to the conventional immersion type membrane arranged in the lower or middle side of wastewater.

The sintered filter 141 is connected to the main pipe 142 through filter coupling member 144 having internal path, and the main pipe 142 is connected to the floating body 143 through a flexible connection member 145. When the floating body 143 and the sintered filters 143 are elevated up and down by changing of water level in the filtration tank 130, a shock can occur between the floating body 143 and the sintered filters 143. The flexible connection member 145 can absorb the shock. The compressed air supply device 152 and the makeup water supply device 160 are connected to the sintered filters 141 through the main pipe 142, just like the suction device 147.

The sintered filter 141 is made of stainless metal powder or synthetic resin fine powder and by a sintering method. The sintered filter 141 is a hollow type filter having a cavity in the center and 0.01˜10 μm of micro-pores. The sintered filter 141 made by the sintering method has uniform pore size and high porosity, and be durable not to be deform the size or shape of micro-pores easily under the high compressed air or back washing water.

As shown FIG. 6, it is advantageous that the sintered filter 141 is formed in the hollow type having a cavity in the center so as to increase the efficiency of filtration or cleaning.

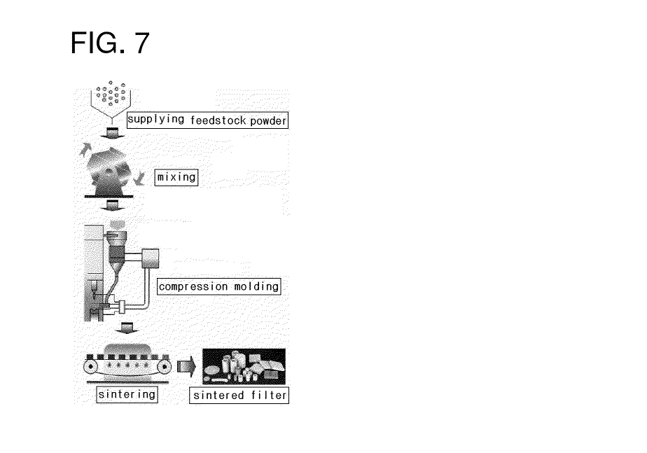

FIG. 7 is a manufacturing process of a sintered filter 141 which is core parts of a floating filter module 140 according to an embodiment of the present invention. Referring to FIG. 7, the manufacturing process comprises the steps of supplying feedstock powder, mixing, compression molding and sintering. The sintering is a molding method in which uniform particle size distribution of powder, that is high purity and high compression, is mixed completely with a precision instrument, and compression formed in a designed shape with a high precision tool having about 3˜7 ton/cm² of pressure. And then, the compression formed body is heated until it reaches the melting point so as to adhere and cement each other.

The sintered filter 141 according to the present invention can be made to put fine powder in a mold, press with high pressure, mold a designed shape, and heat at a temperature near the melting point, in which the fine powder is stainless steel or synthetic resin having a particle size of micrometer order. By heating the molded body of fine powder at the temperature near the melting point, a diffusion bonding or a partial deposition is achieved in contact portion between the body of fine powder so that the fine powder is connected to each other to form a strong porous sintered filter. If adjusting the particle size of fine powder used as a raw material for the sintered filter 141, it is possible to make the sintered filter 141 having various size of micro-pores.

If stainless steel powder is used as a raw material for the sintered filter 141, it is possible to produce a metal porous sintered filter 141 having good heat proof, corrosion proof and durability characteristics. If synthetic resin powder is used as a raw material for the sintered filter 141, it is possible to produce a resin porous sintered filter 141 having good chemical resistant characteristics and low costs.

The sintered filter 141 made by above sintering method has various merits, compared to the conventional immersion type membrane. That is, with adjusting particle size of powder used as a raw material when making, the size of micro-pores can be easily defined as 0.01˜100 μm. Further, the filter used uniform particle size of powder has better porosity than the conventional filter, and can be made in various shapes. Further, the filter is durable not to be deform the size and shape of the micro-pores under long use, and can be cleaned rapidly and effectively by spraying high compressed air, for example 0.2˜0.7 MPa. Because the sintered filter 141 that forms the floating filter module 140 according to the present invention has better porosity than the conventional hollow fiber membrane, the amount of filtration per hour, that is, the filtration rate is also excellent.

The floating body 143 can be made in various materials capable of floating to the water surface. The buoyancy index of the floating body 143 is variously defined according to the total weight of the floating filter module 140 such that the floating body 143 is always positioned at the surface of wastewater. In case that the sintered filter 141 is made of metal material or other frame is added such that the total weight has increased, the floating body can be filled with air or helium (He).

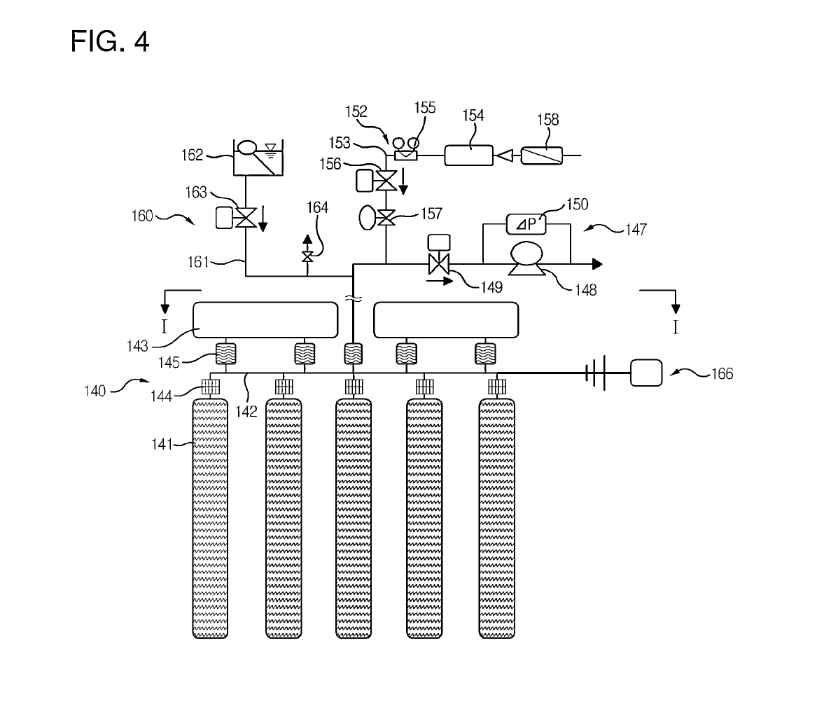

Referring to FIG. 4 again, the suction device 147 includes a suction pump 148 installed in the main pipe 142 and being capable of generating suction force, a treatment water control valve 149 arranged in the upper stream of the main pipe 142 and being capable of controlling the flowing of the treatment water through the main pipe 142, and a differential pressure detector. The suction pump 148 provides the suction force to the sintered filters 141 such that wastewater is flowed into the inside of the sintered filters 141, and pumps the in-flowed filtration water to a treatment water tank 170. As the suction pump 148 for providing filtration power to the sintered filter 141, it is desirable to use a self priming pump or a vacuum self priming pump in which cavitations do not occur even if air is inflowed in some degree.

The differential pressure detector 150 detects pressure loss in forward and backward of the suction pump 148 and provides to a control device 185. The control device 150 receives the detection signal from the differential pressure detector 150 and determines the clogging degree of the sintered filter 141. If the clogging degree of the sintered filter 141 reaches to a predetermined value, the control device 150 stops the separating and filtering process and starts the cleaning process of the sintered filter 141. The value of the pressure loss that is a criterion of the clogging degree of the sintered filter 141 is preset according to the type of the sintered filter 141 or the suction pump 148.

A compressed-air supply device 152 has a compressed-air supply pipe 153, and an air compressor 154, a pressure adjuster 155, a compressed-air control valve 156 and an actuator 157 installed the compressed-air supply pipe 153. The compressed-air supply pipe 153 is connected to the main pipe 142, for supplying air to the sintered filters 141 through the main pipe 142. A dust filter 158 is installed in a suction part of the air compressor 154. The air compressor 154, a pressure adjuster 155, a compressed-air control valve 156 and an actuator 157 are controlled by a control device 185.

In the cleaning process, the control device 185 opens the compressed-air control valve 156, operates the air compressor 154 and the pressure adjuster 155, and sprays the compressed air the sintered filters 141 through the main pipe 142. The cleaning process of the sintered filter 141 with spraying the compressed air is automatically executed by the control device 185 for a preset time, and supplies in a pulse form compressed-air through the actuator 157 to clean effectively.

After the cleaning process of the sintered filter 141 with spraying compressed-air, the inside of the sintered filter 141 is filled with compressed air. In this state, the suction device is restarted and the air remaining the sintered filter 141 and the main pipe 142 is flowed into the suction pump 148, resulting in the cavitations of the suction pump 148. For preventing the cavitations of the suction pump 148, before restarting the suction device 147, a makeup water supply device 160 supplies makeup water to the sintered filter 141 and the main pipe 142.

The makeup water supply device 160 includes a makeup water supply pipe 161 connected to the main pipe 142, a makeup water tank 142 for storing the makeup water, and a makeup water control valve 163 installed in the makeup water supply pipe 161. The makeup water tank 162 may be omitted. In this case, the makeup water supply pipe 161 connects directly to the water main to use water from the water main as the makeup water, or the filtration water filtered through the sintered filter 141 is used as the makeup water. A pump for pumping the makeup water may be installed in the makeup water supply pipe 161. The makeup water supply pipe 161 has a discharge valve 161 for discharging air filled in the sintered filter 141 and the main pipe 142 such that the makeup water is effectively filled in the sintered filter 141 and the main pipe 142.

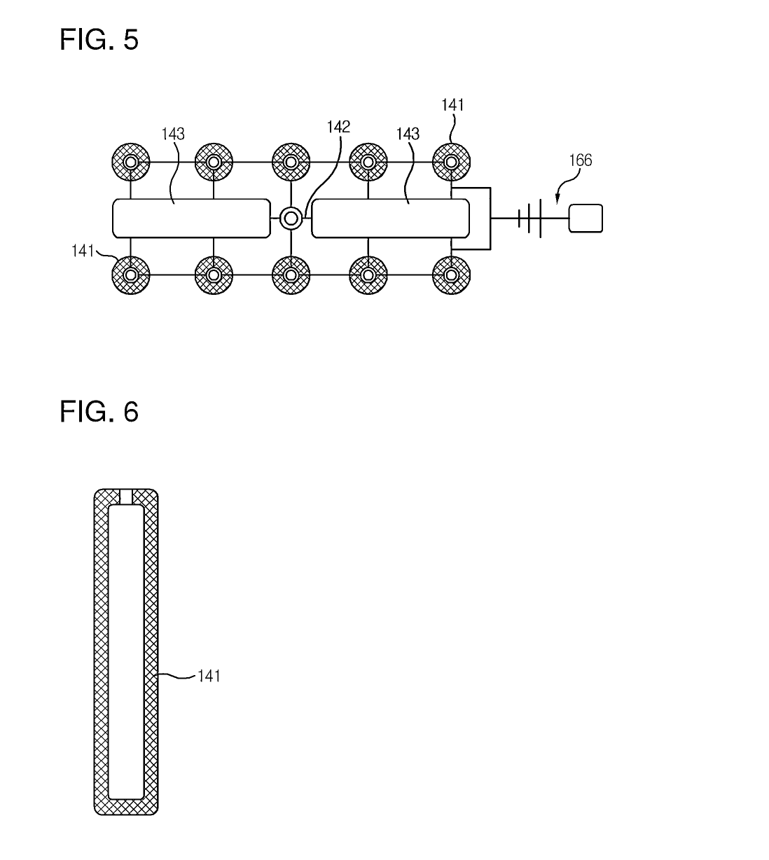

As shown FIGS. 4 and 5, a vibration generating device 166 vibrates the sintered filters through the main pipe 142. It is used various vibration generating devices for generating vibration of a predetermined frequency, for example 1˜200 Hz. The vibration generating device 166 vibrates the sintered filters 141 during the cleaning process or the separating and filtration process so that micro-pollution materials deposited on the sintered filters 141 is removed or reduced.

Hereinafter, the operation of the water treatment apparatus according to the first embodiment of the present invention will now be described in detail with reference to FIGS. 1 to 4.

First, the wastewater is flowed into a flow adjusting tank 110, and flowed into anaerobic tank 114, anoxic tank 120, aerobic tank 125 and filtration tank 130 by turns. A part of wastewater in aerobic tank 125 is returned to the anoxic tank 120, in which nitride nitrogen of wastewater is denitrified to reduce to nitrogen gas so that nitrogen is removed from wastewater. The filtered water in which micro-pollution materials is removed by the floating filter module 140 in the filtration tank 130, is discharged by the way of the treatment water tank 170. The sludge is collected in a sludge pit 138 arranged in the lower side of the filtration tank 130 and pulled out to a sludge thickener 175. A part of sludge pulled out from the filtration tank 130 is returned to the anaerobic tank 115. This maintains steady microbial concentration of the whole reactor, releases phosphorus in anaerobic state and allows microorganism to eat excessive phosphorus in the aerobic tank 125, thereby increasing total phosphorus content within sludge and the total phosphorus removal rate.

The water treatment process is described in more detail below. The wastewater is sucked into the inside of the sintered filters 141, and after the micro-pollution particles included in the wastewater are separated and filtered, the wastewater is flowed into the treatment water tank 170 through the main pipe. During the separating and filtering process with the sintered filter 141, the agitation device 132 agitates wastewater to prevent sludge of wastewater from depositing and being anaerobic. The bubble generating device 133 supplies bubbles to the sintered filter 141 so that the adhering amount of micro-pollution particles or microorganism on the sintered filter 141 is decreased. Further, the vibration generating device 166 vibrates the sintered filter 141 during the separating and filtering process so that micro-pollution particles or microorganism is hardly adhered on the sintered filter 141.

The separating and filtering process with the floating filter module 140 is executed when the wastewater level in the filtration tank 130 is within a predetermined range. That is, according to the wastewater level from the water level detection device 131, the control device 185 operates the suction device 147, the agitation device 132 and the bubble generating device 133. If the wastewater level is lower than the predetermined low level, the separating and filtering process is not progressed. If the floating filter module 140 operates when the wastewater level is lower than the predetermined low level, the wastewater having high concentration of suspended solids is passed through the sintered filter 141. This clogs rapidly the sintered filter 141 so that it is impossible to operate effectively.

On the other hand, the control device 185 checks the clogging degree of the sintered filter 141 by the differential pressure detector 150. When the clogging degree of the sintered filter 141 reaches to the predetermined value, the control device 185 stops the separating and filtering process and proceeds to the cleaning process for the sintered filter 141. The detailed cleaning process is as follows.

When the clogging degree of the sintered filter 141 reaches to the predetermined value, the control device 185 closes the treatment water control valve 149 and stops the suction pump 148. And then, the control device 185 opens the compressed-air control valve 156 and operates the air compressor 154, the pressure adjuster 155 and actuator 157 so as to supply the compressed-air having a predetermined pressure, for example 0.2˜0.7 MPa, to the sintered filter 141. When the compressed-air is supplied to the sintered filter 141, the filtrate filled in the sintered filter 141 is strongly pushed out by the compressed-air and rapidly gets out of the outside of the sintered filter 141 through the micro-pores of the sintered filter 141.

The filtrate getting out instantaneously functions a back washing water to remove micro-pollution particles adhered on the sintered filter 141. Next, the compressed-air supplying to the inside of the sintered filter 141 passes through micro-pores of the sintered filter 141 and discharges to the outside of the sintered filter 141, and the micro-pollution particles adhered on the sintered filter 141 are removed. The compressed-air is provided in a pulse form by the actuator 157 or provided successively without the operation of the actuator 157.

The cleaning process with returning of filtration water and spraying of the compressed-air is preceded by the control device 185 for a predetermined time. After the cleaning process, the control device 185 closes the compressed-air control valve 156, stops the compressed-air supply device 152, and operates the makeup water supply device 160. When the makeup water control valve 163 and a discharge valve 164 are opened and the makeup water stored in the makeup water tank 162 is filled in the main pipe 142 and the sintered filters 141 through the makeup water supply pipe 161. This prevents the suction pump from cavitating in the separating and filtering process.

A monitoring device 180, a remote management device 190 and a communication device 195 are provided the information for the separating and filtering process, the cleaning process and defects of devices, to a manager. The manager remotely controls the separating and filtering process through the remote management control device 190 in home or office.

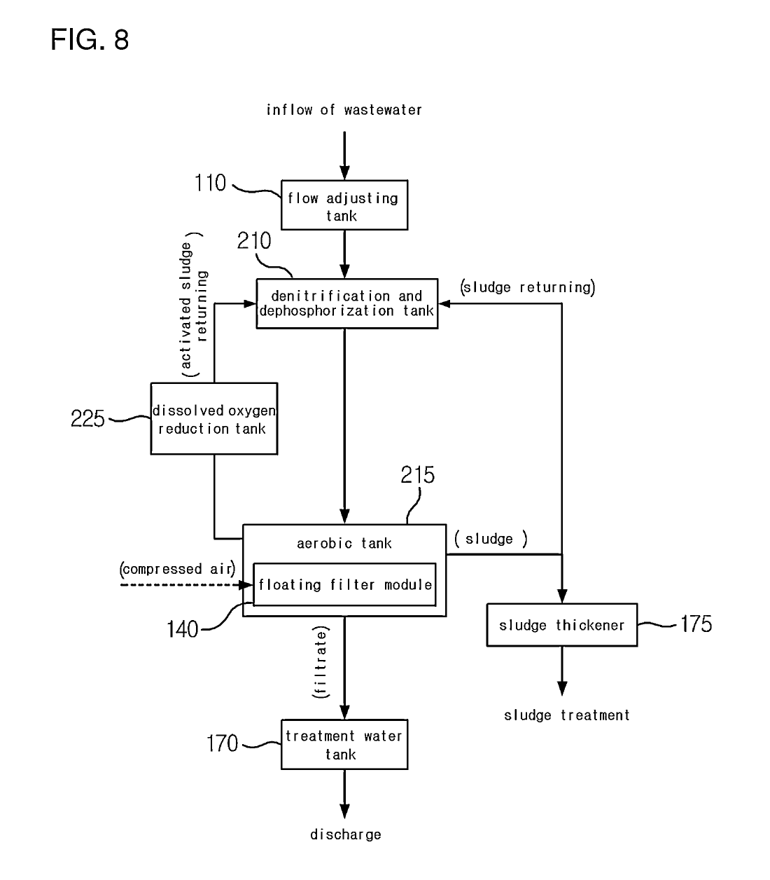

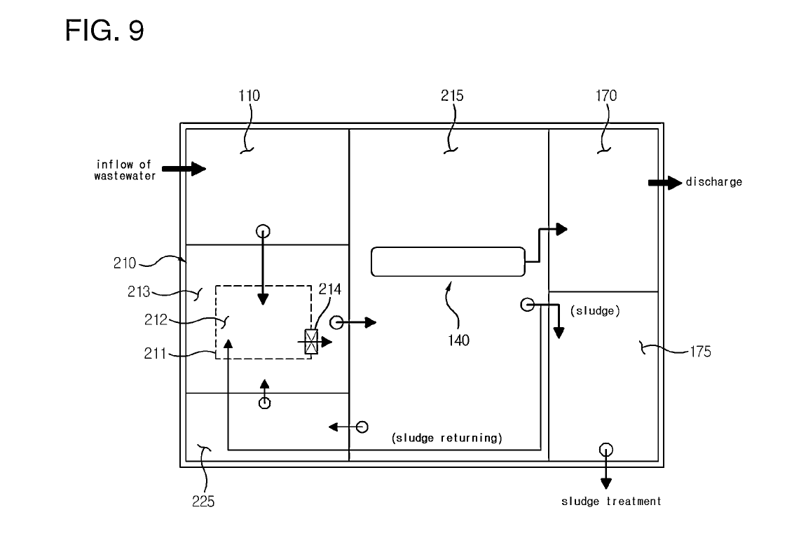

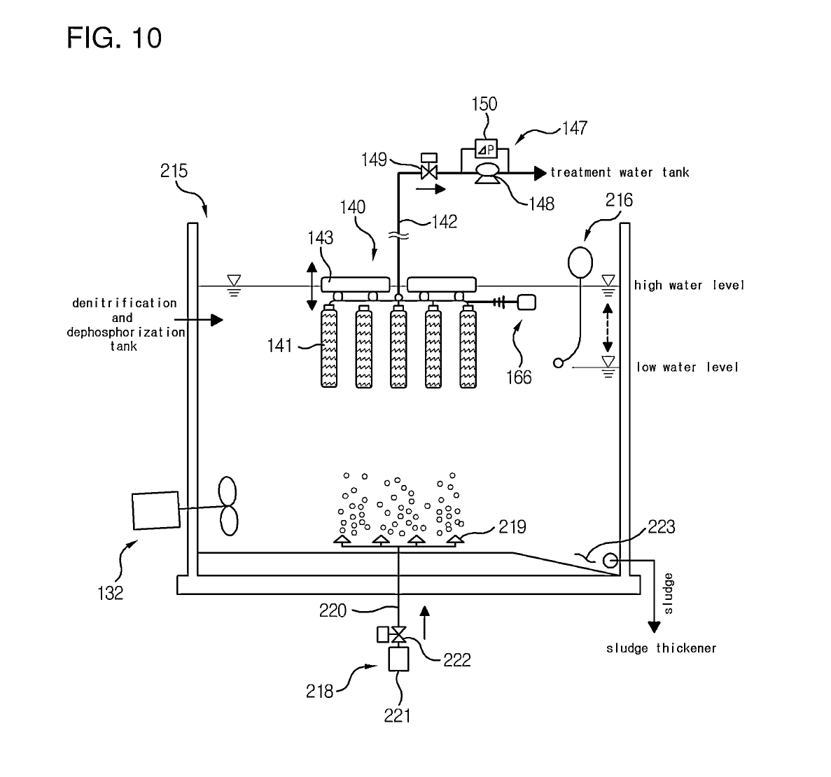

On the other hand, FIG. 8 is a flowsheet showing the wastewater treatment processes of a water treatment apparatus according to a second embodiment of the present invention and FIG. 9 is a top view schematically showing the water treatment apparatus of FIG. 8.

The wastewater treatment apparatus according to the second embodiment of the present invention is medium and small sized wastewater treatment apparatus and includes a water flow adjusting tank 110; a denitrification and dephosphorization tank 210 for executing both functions of the anaerobic tank and anoxic tank according to the first embodiment of the present invention, and maintaining the concentration of dissolved oxygen below a predetermined level, for example 0.2 mg/L; an aerobic tank 215 in which the floating filter module 140 is installed; a dissolved oxygen reduction tank 225 for reducing the dissolved oxygen of the treatment solution returned to the denitrification and dephosphorization tank 210 to improve the denitrification and dephosphorization efficiency; a treatment water tank 170 in which the treatment water through the aerobic tank 214 is flowed in; and a sludge thickener 175 in which the sludge discharged from the aerobic tank 214 is flowed in.

The denitrification and dephosphorization tank 210 is divided into an anaerobic region 212 and an anoxic region 213 by a partition wall, and the anaerobic region 212 and the anoxic region 213 are connected through a pathway 214. The water treatment apparatus according to the second embodiment of the present invention is designed to process wastewater under 10,000 ton/day.

Referring to FIG. 10, the water treatment apparatus according to the second embodiment of the present invention further includes a water level detection device 216 for detecting the level of the wastewater in the aerobic tank 215, a agitation device 217 for wastewater of the aerobic tank 215, and a aerobic device 218 for supplying air to the wastewater of the aerobic tank 215. The aerobic device 218 includes a plurality of aeration tube 134 arranged within the wastewater of the aerobic tank 215, an air supply device 221 for supplying air to the aeration tube 219 through a air supply tube 220 connected to the aeration tube 219, and an air control valve 222 installed in the air supply tube 220. The floating filter module 140 for separating and filtering micro-pollution particles of wastewater is installed in the aerobic tank 215, and a sludge pit 223 for collecting sludge is provided in the lower side of the aerobic tank 215. In FIG. 10, the compressed-air supply device 152 and the makeup water supply device 160 are omitted for clarity, and the floating filter module 140 is the same as that of the first embodiment of the present invention.

The water treatment apparatus according to the second embodiment of the present invention, but not shown in the drawings, further includes a monitoring device for providing the water treatment processing state to a user, a control device for controlling various devices, a remote management device and a communication device, in the same as the first embodiment.

Hereinafter, the water treatment process with water treatment apparatus according to the second embodiment of the present invention will now be described. First, the wastewater is flowed into the anaerobic region 212 of the denitrification and dephosphorization tank 210 by way of the flow adjusting tank 110. In addition to the wastewater, a portion of sludge discharged from the aerobic tank 215 to the sludge thickener 175 is flowed into the anaerobic region 212. Accordingly, a P-release mechanism is occurred in the anaerobic region 212, and in the aerobic tank 215, microorganism eats excessive phosphorus to increase total phosphorus content within sludge, thereby improving the total phosphorus removal rate. The nitride solution nitrified in the aerobic tank 215 is returned to the anoxic region 213 of the denitrification and dephosphorization tank 210, and denitrified and reduced to remove the nitrogen component of water. The treatment solution returned from the aerobic tank 215 to the denitrification and dephosphorization tank 210 is passed through the dissolved oxygen reduction tank 225 to reduce the dissolved oxygen, thereby improving the denitrification and dephosphorization efficiency in the denitrification and dephosphorization tank 210.

As shown FIG. 10, the wastewater passed through the denitrification and dephosphorization tank 210 is flowed into the aerobic tank 215. In the aerobic tank 215, microorganism mechanism such as organic matter decomposition, nitrification reaction and excess phosphorus ingestion is occurred and, at the same time, micro-pollution particles is separated and filtered by the floating filter module 140. The separating and filtering process with the floating filter module 140 is the same as above described. As shown in drawings, by arranging the floating filter module 140 in the upper side of the aerobic device 218 and using bubbles supplied from the aerobic device 218 into water, it is possible to decrease micro-pollution particles or microorganism adhered on the sintered filter 141 of the floating filter module 140.

In the operation of the floating filter module 140 of the water treatment apparatus according to the second embodiment of the present invention, if the separating and filtering process is executed during aeration rest period, the upper water having relatively low concentration of suspension solids is filtered by the sintered filter 141, thereby being capable of separating and filtering effectively. In the floating filter module 140 of the water treatment apparatus according to the second embodiment of the present invention, it is desirable that the operation range between high and low water levels is narrow. This minimizes the concentration change of suspended solids in the wastewater to be separated and filtered by the sintered filter 141.

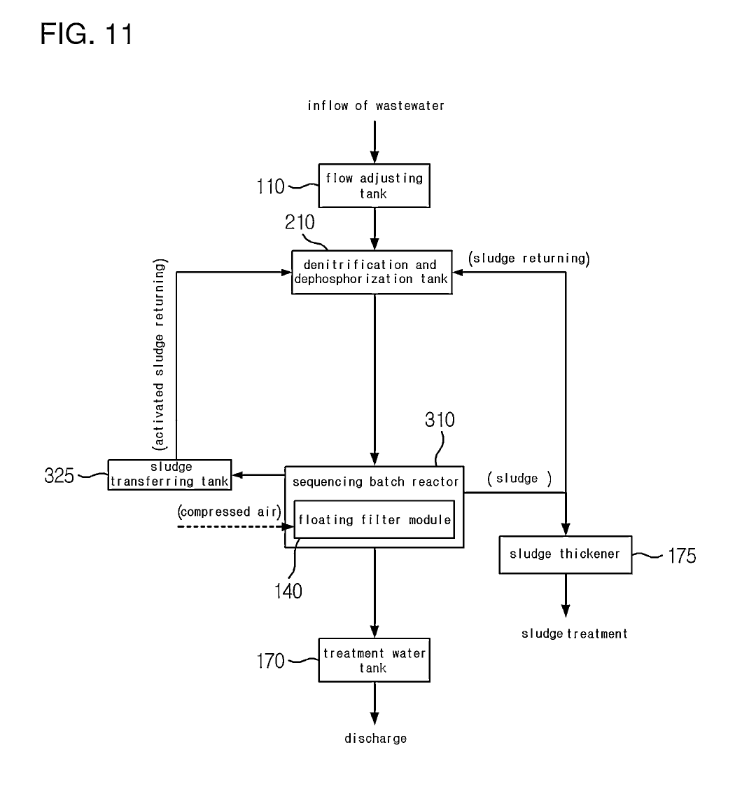

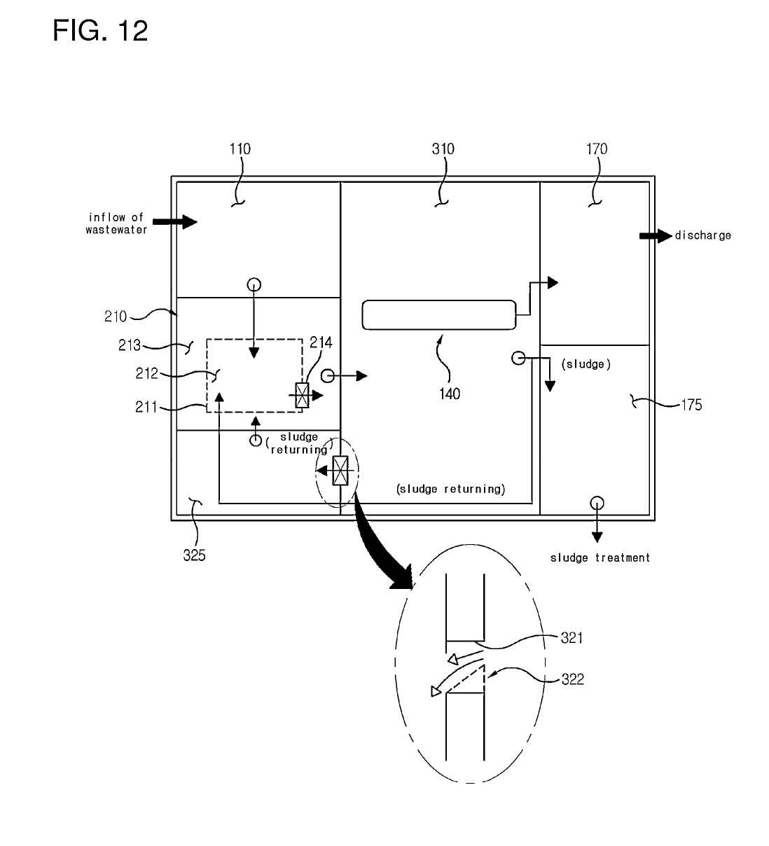

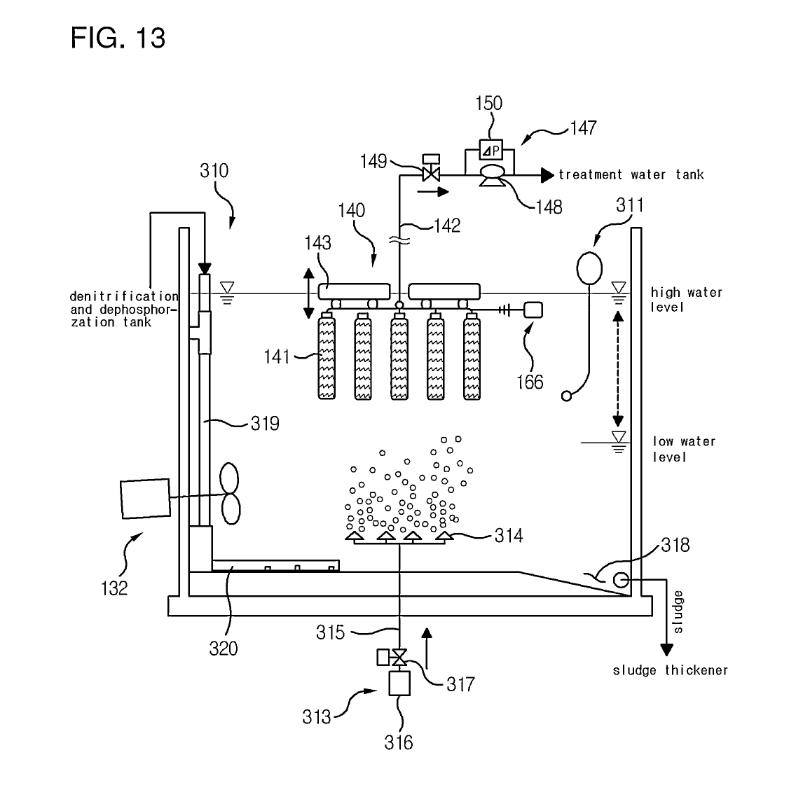

On the other hand, FIG. 11 is a flowsheet showing the wastewater treatment process of a water treatment apparatus according to a third embodiment of the present invention, FIG. 12 is a top view schematically showing a water treatment apparatus according to a third embodiment of the present invention, and FIG. 13 is a side view schematically showing a sequencing batch reactor of a water treatment apparatus according to a third embodiment of the present invention.

The water treatment apparatus according to the third embodiment of the present invention is a sequencing wastewater treatment apparatus using a sequencing batch reactor (SBR) 310 for executing a series of processes that is inflowing—microorganism reacting—depositing—discharging, and includes a flow adjusting tank 110, a denitrification and dephosphorization tank 210, a sequencing batch reactor 310, a sludge transferring tank 325, a treatment water tank 170 and a sludge thickener 175. The denitrification and dephosphorization tank 210 is divided into an anaerobic region 212 and an anoxic region 213 by a partition wall so that the phosphorus removal reaction and the nitrogen removal reaction are not interfered each other. The anaerobic region 212 and the anoxic region 213 are connected through the pathway 214.

According to a conventional sequencing wastewater treatment method using a sequencing batch reactor 310 in major reaction process, the inflowing of wastewater—microorganism reacting—depositing—discharging are done in the sequencing batch reactor 310, and the mechanism for removing nitrogen, phosphorus and nutrient salts is done only in the sequencing batch reactor 310. Thus, the removal efficiency of nitrogen, phosphorus and nutrient salts may be relatively low. According to the present invention, however, because the denitrification and dephosphorization tank 210 having the anaerobic region 212 and the anoxic region 213 is arranged in the upper stream of the sequencing batch reactor 310, the removal efficiency of nitrogen, phosphorus and nutrient salts is more excellent than the conventional sequencing wastewater treatment method.

Referring to FIG. 13, the water treatment apparatus according to the third embodiment of the present invention includes a water level detection device 311 for detecting the level of the wastewater in the sequencing batch reactor 310, a agitation device 312 for wastewater of the sequencing batch reactor 310, and a aerobic device 313 for supplying air to the wastewater of the sequencing batch reactor 310. The aerobic device 313 includes a plurality of aeration tube 314 arranged within the wastewater of the sequencing batch reactor 310, an air supply device 316 for supplying air to the aeration tube 314 through a air supply tube 315 connected to the aeration tube 314, and an air control valve 317 installed in the air supply tube 315.

The floating filter module 140 for separating and filtering micro-pollution particles of wastewater is installed in the sequencing batch reactor 310, and a sludge pit 318 for collecting sludge is provided in the lower side of the sequencing batch reactor 310. In FIG. 13, the compressed-air supply device 152 and the makeup water supply device 160 are omitted for clarity, and the floating filter module 140 is the same as that of the first embodiment of the present invention.

The water treatment apparatus according to the third embodiment of the present invention, but not shown in the drawings, further includes a monitoring device for providing the water treatment processing state to a user, a control device for controlling various devices, a remote management device and a communication device, in the same as the first embodiment.

Hereinafter, the water treatment process with water treatment apparatus according to the third embodiment of the present invention will now be described. First, wastewater is temporarily stored in the flow adjusting tank 110, and flowed into the anaerobic region 212 of the denitrification and dephosphorization tank 210 intermittently or sequentially. In the anaerobic region 212, the phosphorus (PO₄—P) releasing speed by microorganism is increased. The wastewater in which phosphorus is released is flowed into the anoxic region 213. In the anoxic region 213, by the mechanism of facultative anaerobe denitrification microorganism, the nitrate nitrogen (NO₃—N) and nitrite nitrogen (NO₂—N) are reduced into nitrogen gas so that the removal efficiency of the nitrogen and phosphorus is improved. The wastewater of the anoxic region 213 is transferred to the sequencing batch reactor 310.

As shown FIGS. 12 and 13, the wastewater passed through the denitrification and dephosphorization tank 210 is dispersed and flowed into the lower side of the sequencing batch reactor 310 through a guide tube 319 and a spray tube 320 connected thereto. In the sequencing batch reactor 310, the wastewater is agitated by the agitation device 312, and an aerobic process is executed during a predetermined time by bubbles provided from the aerobic device 313. The sludge included in the wastewater is collected in the sludge pit 318 and transferred to the sludge thickener 175. The upper water is separated and filtered by the floating filter module 140 to discharge to the treatment water tank 170. The sludge flowed into the sludge thickener 175 is dehydrated after a predetermined sludge retention time (SRT), and the treatment water transferred to the treatment tank 170 is transiently retained and discharged to outside.

A portion (approximately under 30%) of sludge pulled out from the sequencing batch reactor 310 is returned to the anaerobic region 212 of the denitrification and dephosphorization tank 210. This promotes the phosphorus removal reaction, and maintains the concentration of suspended solids within the denitrification and dephosphorization tank 210 at a certain level, for example 3,000˜20,000 mg/L, even in case of emergency.

The sequencing batch reactor 310 is connected to the sludge transferring tank 325 through a pathway 321 having a whirlpool prevention device 322. Through the pathway 321, the activated sludge and nitrate nitrogen (NO₃—N) are flowed from sequencing batch reactor 310 into the sludge transferring tank 325, and returned to the anoxic region 213 of the denitrification and dephosphorization tank 210. This maintains the concentration of suspended solids within the anoxic region 213 at a certain level, for example 3,000˜20,000 mg/L, the returned nitrate nitrogen (NO₃—N) is reduced to nitrogen gas (N2). In the sludge transferring tank 325, the dissolved oxygen of the activated sludge and nitride solution transferred from the sequencing batch reactor 310 is decreased to return the anoxic region 213 in absorbable form. Accordingly, the nitrogen removal reaction by facultative anaerobe microorganism is more promoted.

The floating filter module 140 installed in the sequencing batch reactor 310 separates and filters micro-pollution particles of the upper water and transfers it to the treatment water tank 170. The detailed structure and operation of the floating filter module 140 is the same as above described, and the operation of the floating filter module 140 is done when the level of the wastewater is within a predetermined range between high and low water levels.

In the water treatment apparatus according to the third embodiment of the present invention, the floating filter module 140 and the denitrification and dephosphorization tank 210 are used in the sequencing batch wastewater treatment process, thereby being capable of simplifying the process, upgrading facilities and improving the water treatment efficiency.

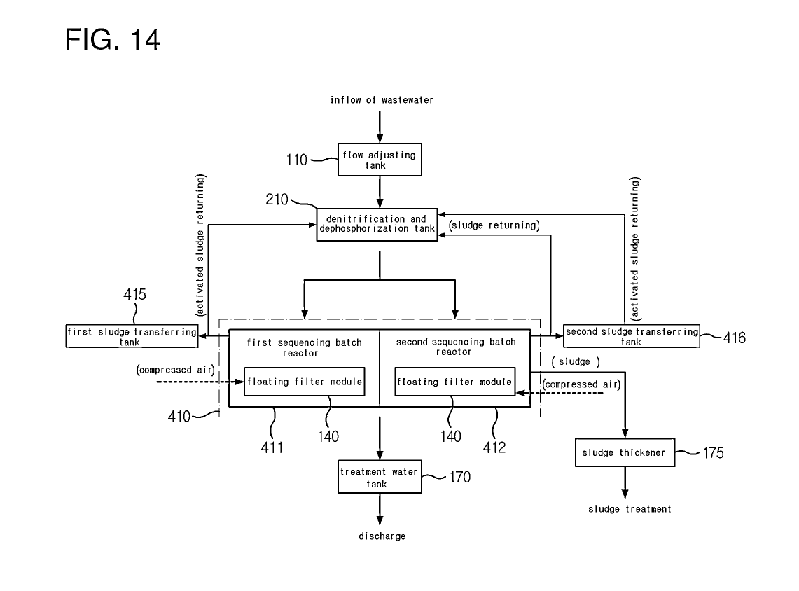

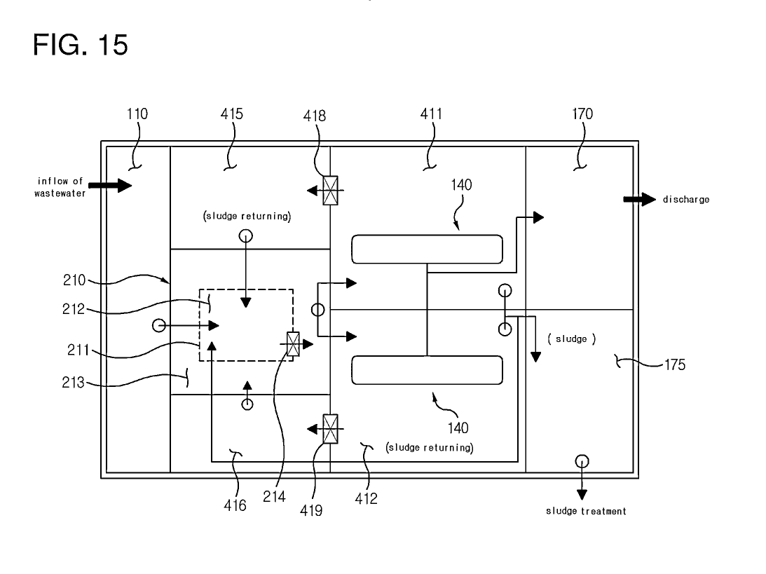

On the other hand, FIG. 14 is a flowsheet showing the wastewater treatment processes of a water treatment apparatus according to a forth embodiment of the present invention, and FIG. 15 is a top view schematically showing a water treatment apparatus according to a forth embodiment of the present invention.

The water treatment apparatus according to the forth embodiment of the present invention is a semi-batch type or a semi-continuous type of wastewater treatment apparatus in which a main reaction process uses an alternating batch reactor 410 having two batch reactors 411 and 412. The water treatment apparatus according to the forth embodiment of the present invention includes a flow adjusting tank 110, a denitrification and dephosphorization tank 210, an alternating batch reactor 410, two sludge transferring tank 415 and 416, a treatment water tank 170 and a sludge thickener 175.

The water treatment apparatus according to the forth embodiment of the present invention is the same constitutions as the apparatus according to the third embodiment except that two of the batch reactors 412 and 413 and two of the sludge transferring tanks 415 and 416 are provided. The first batch reactor 411 is connected to the first sludge transferring tank 415 through a pathway 418, and the second batch reactor 412 is connected to the second sludge transferring tank 416 through a pathway 419.

The first batch reactor 411 and the second batch reactor 412 have the floating filter module 140 for filtering the upper water of wastewater, respectively. The detailed structure and operation of the floating filter module 140 is the same as above described. Two floating filter modules 140 installed in the first batch reactor 411 and the second batch reactor 412 can be operated alternatively and, as the case may be, used to share the suction device 147, the compressed air supply device 152 and the makeup water supply device 160.

The drawings show two of the batch reactors 412 and 413 and two of the sludge transferring tanks 415 and 416, but the number of the batch reactors and the sludge transferring tanks are changed variously. And according to the number of the batch reactors, the number of the floating filter module 140 is changed.

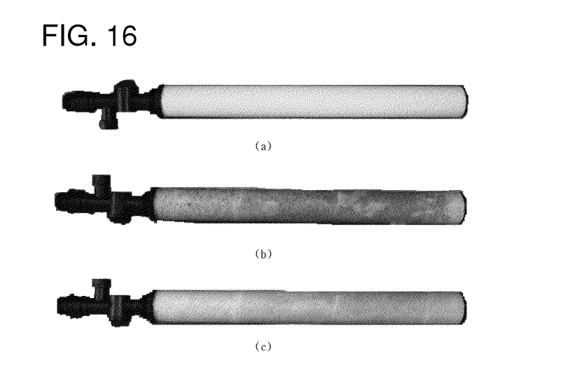

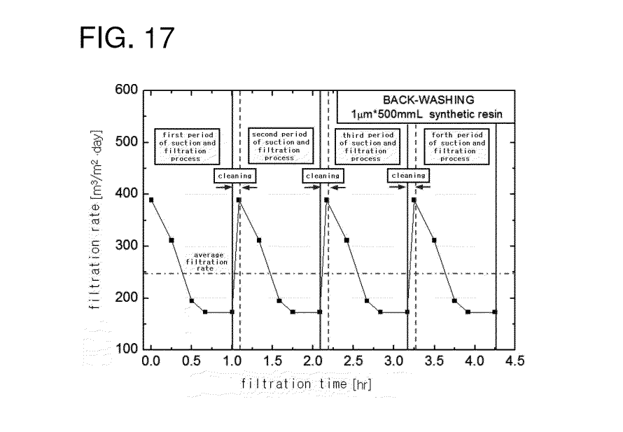

On the other hand, FIG. 16 is a view respectively showing (a) an installation initial state, (b) a state after sucking and filtering, and (c) a state after cleaning with compressed air, of the sintered filter provided to the floating filter module in the sequencing batch reactor, and FIG. 17 is a graph showing filtering characteristics according to the operation of the floating filter module installed in a sequencing batch reactor.

In this case, the sintered filter is made of synthetic resins, the concentration of suspended solids is 60 mg/L in the sequencing batch reactor, and the cleaning process is executed by the returning of treatment water and the spraying of the compressed air during 5 minutes.

Referring to FIG. 16, it is can be confirmed that the surface of the sintered filter after the sucking and filtering (b) is totally contaminated by adhering micro-pollution particles and microorganism, compared with the initial state (a). Further, the state after cleaning (c) shows that almost micro-pollution particles and microorganism is removed from the surface of the sintered filer.

Referring to FIG. 17, from the filtration characteristics after cleaning and operating the sintered filter by one hour period, it is can be confirmed that the filtration rate of the sintered filter is excellent at first, and gradually decreased over time by adhering micro-pollution particles and microorganism. However, the filtration rate of the sintered filter after 5 minutes of cleaning is returned to that of the initial state. On operating the sintered filter for 4 weeks, the average filtration rate is 248.2 m³/m²·day, this is excellent more than that of the conventional immersion type membrane (MBR)? in which the average filtration of the hollow fiber is 20˜50 m³/m²·day. The reason why the porosity of the sintered filter is high, microspores are solidity, and the cleaning with returning of the treatment water and spraying of compressed air is possible.

As described above, the floating filter module 140 according to the present invention has various advantages, compared with the conventional immersion type membrane. First, a semi-permanent sintered filter 141 is used, in which the micro pores are not deformed. Second, the whole filter module 140 is the floating and flow type and arranged in the upper side of the water treatment tank, and the upper water that has relatively low concentration of suspended solids is separated and filtered. Third, a bubbles or vibration generating means is used for reducing the clogging of the sintered filter 141. Forth, when the sintered filter is clogged, the micro-pollution particles and microorganism adhered on the sintered filter 141 are rapidly removed by returning of the filtration water and spraying of the compressed air. The characteristics distinguished from the conventional immersion type membrane are described below in table 1.

TABLE 1

| | CONVENTIONAL | |
|---|---|---|
| | IMMERSION TYPE | |
| | MEMBRANE | FLOATING |
| ITEM | SEPARATOR | FILTER MODULE |
| Separation/filtration | Hollow fiber membrane or | Sintered filter |
| means | flatsheet membrane | |
| Filter module | Fixed immersion type | Movable floating type |
| installation type | | |
| Region for | High concentration of | Low concentration of |
| separating/filtering | suspended solids region | upper water |
| Material of | Synthetic resin | Stainless steel or |
| filtration means | | synthetic resin |
| Size of micro | 0.01~1.0 | 0.01~10 |
| pore (μm) | | |
| Porosity | Medium | High |
| Means for reducing | Coarse bubble | Coarse bubble and |
| the clogging | | vibration |
| Cleaning method of | Returning of treatment | Returning of filtration |
| filtration means | water | water and spraying of |
| | | compressed air |
| Chemicals for | Used | Unused |
| cleaning | | |
| Durability of | Possibility of breakage | Semi-permanent |
| filtration means | or damage is high. | |
| Filtration rate | Medium | High |

The floating filter module 140 according to the present invention, as described above, is installed in various water treatment tank such as a filtration tank 130, an aerobic tank 215, a sequencing batch reactor 310, and an alternating batch reactor 410. Thus, various water treatment apparatuses are upgraded to high facilities effectively, and complex water treatment apparatus is simplified

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A floating filter module comprising:
a hollow-type sintered filter arranged in wastewater of the water treatment tank and having a plurality of micro-pores, for separating and filtering the micro-pollution particles from the wastewater introduced into the water treatment tank;
a floating body coupled with the sintered filter and floated to the surface of the wastewater in the water treatment tank, for placing the sintered filter at the upper side of the wastewater in the water treatment tank;
a main pipe for connecting to an inside space of the sintered filter;
a suction device coupled to the main pipe and providing suction force to the sintered filter through the main pipe, for sucking the wastewater of the water treatment tank into the inside space of the sintered filter through the plurality of micro-pores; and
a compressed-air supply device having a compressed-air supply pipe connecting with the inside space of the sintered filter through the main pipe and an air compressor coupled with the compressed-air supply pipe, for supplying compressed air into the inside space of the sintered filter to remove the micro-pollution particles that clog the micro-pores of the sintered filter.

2. The floating filter module according to claim 1, further comprising a vibration generating device for vibrating the sintered filter to remove the micro-pollution particles that clogs the micro-pores of the sintered filter.

3. The floating filter module according to claim 1, further comprising a makeup water supply device for supplying makeup water in the inside space of the sintered filter filled with air by the compressed-air supply device, the makeup water supply device being connected to the main pipe.

4. The floating filter module according to claim 1, wherein the sintered filter is made of stainless metal or synthetic resin.

5. The floating filter module according to claim 1, wherein the suction device comprises a suction pump and a differential pressure detector, the suction pump being connected with the main pump to generate suction force, and the differential pressure detector detecting the difference between the forward and backward pressures of the suction pump to detect the blockage degree of the sintered filer.

6. The floating filter module according to claim 1, wherein the compressed-air supply device further comprises an actuator arranged between the sintered filter and the air compressor, for converting the compressed air to pulse form, the compressed air being continuously supplied from the air compressor to the sintered filter.

7. A water treatment apparatus comprising:
a water treatment tank into which wastewater is introduced;
a floating filter module arranged in the water treatment tank, for separating and filtering the micro-pollution particles from the wastewater introduced into the water treatment tank;
a control device for controlling operations of the floating filter module,
wherein the floating filter module comprises:
a hollow-type sintered filter arranged in the wastewater of the water treatment tank and having a plurality of micro-pores;
a floating body coupled with the sintered filter and floated to the surface of the wastewater in the water treatment tank, for placing the sintered filter at the upper position of the wastewater in the water treatment tank;
a main pipe for connecting with an inside space of the sintered filter;
a suction device coupled to the main pipe and providing suction force to the sintered filter through the main pipe, for sucking the wastewater of the water treatment tank into the inside space of the sintered filter through the plurality of micro-pores; and
a compressed-air supply device having a compressed-air supply pipe connecting with the inside space of the sintered filter through the main pipe and an air compressor coupled with the compressed-air supply pipe, the compressed-air supply device supplying compressed air into the inside space of the sintered filter to remove the micro-pollution particles that clog the micro-pores of the sintered filter.

8. The water treatment apparatus according to claim 7, further comprising a bubble generating device for supplying bubbles to the sintered filter and removing the micro-pollution particles adhered to sintered filter, the bubble generating device including an aeration tube arranged in the position lower than the sintered filter in the wastewater of the water treatment tank and air supply device for introducing air into the aeration tube through an air supply tube connected the aeration tube.

9. The water treatment apparatus according to claim 7, further comprising a water level detection device for detecting the level of the wastewater in the water treatment tank and sending the detected signal to the control device, the control device enabling to operate the floating filter module when the level of the wastewater in the water treatment tank is within a preset range.

10. The water treatment apparatus according to claim 7, further comprising;
a remote management device for providing a manager with information about the water treatment processing state and allowing the manager to control remotely the water treatment processes; and
a communication device used for communication between the control device and the remote management device.

11. The water treatment apparatus according to claim 7, further comprising an anaerobic tank for releasing phosphorus included in the wastewater; an anoxic tank for removing nitrogen included in the wastewater; an aerobic tank for providing air into the wastewater to allow microorganism of wastewater to eat excessive phosphorus,
wherein the anaerobic tank, the anoxic tank and the aerobic tank are arranged in order on the upper stream of the water treatment tank and a portion of sludge discharged from the water treatment tank is returned to the anaerobic tank.

12. The water treatment apparatus according to claim 7, further comprising a denitrification and dephosphorization tank arranged in the upper stream of the water treatment tank, wherein the denitrification and dephosphorization tank is divided into an anaerobic region for releasing phosphorus included in the wastewater and an anoxic region for removing nitrogen included in the wastewater by a partition wall, the wastewater introduced into the anaerobic region flows into the anoxic region through a pathway provided in the partition wall and then into the water treatment tank, and a portion of sludge discharged from the water treatment tank is returned to the anaerobic tank.

13. The water treatment apparatus according to claim 7, wherein the water treatment tank has an aeration device for supplying air into the wastewater, the water treatment tank being a sequencing batch reactor (SBR) in which the inflowing of wastewater, the microbial reaction, the precipitation and the discharging of wastewater are executed in the same space so that mechanism for removing nitrogen, phosphorus and nutrient salts is occurred.

14. The water treatment apparatus according to claim 13, further comprising a denitrification and dephosphorization tank arranged in the upper stream of the sequencing batch reactor, wherein the denitrification and dephosphorization tank is divided into an anaerobic region for releasing phosphorus included in the wastewater and an anoxic region for removing nitrogen included in the wastewater by a partition wall, the wastewater introduced into the anaerobic region flows into the anoxic region through a pathway provided in the partition wall and then into the sequencing batch reactor, and a portion of sludge discharged from the sequencing batch reactor is returned to the anaerobic tank.

15. The water treatment apparatus according to claim 14, further comprising a sludge transferring tank arranged between the denitrification and dephosphorization tank and the sequencing batch reactor, in which the dissolve oxygen of the activated sludge and nitrogen solution discharged from the sequencing batch reactor is reduced and then returned to the anoxic region of the denitrification and dephosphorization tank.

16. The water treatment apparatus according to claim 7, wherein the water treatment tank has a aeration device for supplying air into the wastewater, the water treatment tank being an alternating sequencing batch reactor having a plurality of sequencing batch reactors (SBR) in which the inflowing of wastewater, the microbial reaction, the precipitation and the discharging of wastewater are executed in the same space so that mechanism for removing nitrogen, phosphorus and nutrient salts is occurred, and the control device operates alternatively a plurality of floating filter modules installed in the plurality of sequencing batch reactors, respectively.

17. The water treatment apparatus according to claim 16, further comprising a denitrification and dephosphorization tank arranged in the upper stream of the alternating sequencing batch reactor, wherein the denitrification and dephosphorization tank is divided into an anaerobic region for releasing phosphorus included in the wastewater and an anoxic region for removing nitrogen included in the wastewater by a partition wall, the wastewater introduced into the anaerobic region flows into the anoxic region through a pathway provided in the partition wall and then into the plurality of sequencing batch reactors, and a portion of sludge discharged from the plurality of sequencing batch reactors is returned to the anaerobic tank.

18. The water treatment apparatus according to claim 17, further comprising at least one sludge transferring tank arranged between the denitrification and dephosphorization tank and the plurality of sequencing batch reactors, in which the dissolve oxygen of the activated sludge and nitrogen solution discharged from the plurality of sequencing batch reactor is reduced and then returned to the anoxic region of the denitrification and dephosphorization tank.

19. A water treatment method, which comprises the steps of:
(a) arranging a hollow-type sintered filter having a plurality of micro-pores in the upper side of wastewater in the water treatment tank, by using of a floating body capable of floating on the surface of water;
(b) separating and filtering the micro-pollution particles from the wastewater, by providing suction force for the sintered filter and by sucking the wastewater of the water treatment tank into the inside space of the sintered filter through the plurality of micro-pores;
(c) detecting the blockage degree of the sintered filter;
(d) cleaning the sintered filter with returning of filtration water and spraying of compressed air to the inside space of the sintered filter, by stopping a suction device for providing the sintered filter with suction force and by supplying compressed air into the inside space of the sintered filter for a period of time, when the blockage degree of the sintered filter reaches a preset value, and
(e) stopping a compressed air supply device for supplying compressed air to the sintered filter and restarting the suction device, after the cleaning of the sintered filter.

20. The water treatment method according to claim 19, wherein in the step (b), the micro-pollution particles adhered to sintered filter are removed by supplying bubble to the sintered filter through an aeration tube arranged in the position lower than the sintered filter in the wastewater of the water treatment tank.

21. The water treatment method according to claim 19, wherein in the step (b) or (d), by vibrating the sintered filter, the micro-pollution particles that clog the micro-pores of the sintered filter is removed from the sintered filter.

22. The water treatment method according to claim 19, wherein after the step (d) and before step (e), the makeup water is provided in the sintered filter filled with compressed-air to fill up the inside space of the sintered filter.

23. The water treatment method according to claim 19, after the step (a), further comprising detecting the level of the wastewater in the water treatment tank, wherein the steps after the step (b) are executed only when the level of the wastewater in the water treatment tank is within a preset range.

24. The water treatment method according to claim 19, wherein in the step (c), the blockage degree of the sintered filter is detected by detecting pressure loss in the front and the back of a suction pump for providing the sintered filter with suction force.
